(19) United States
(12) Patent Application Publication
(10) Pub. No.: US 2023/0292091 A1
(43) Pub. Date: Sep. 14, 2023

(54) Electronic Label Localization and Mesh Network Desynchronization

(71) Applicant: MonoLets, Inc., Mountain View, CA (US)

(72) Inventors: Tengfei Chang, Santa Clara, CA (US); Osama Khan, Mountain View, CA (US)

(21) Appl. No.: 18/178,353

(22) Filed: Mar. 3, 2023

Related U.S. Application Data
(60) Provisional application No. 63/319,011, filed on Mar. 11, 2022.

(51) Int. Cl. H04W 4/029; H04W 56/00

(52) U.S. Cl. CPC H04W 4/029; H04W 56/002; H04W 84/18

(57) ABSTRACT

Various exemplary embodiments include a method for presence detection based on three-dimensional localization of electronic labels, comprising placing one or more fixed anchor electronic labels in known positions in three-dimensional space, sending data packets via radio frequency signals from one or more unknown positioned electronic labels, wherein the radio frequency signals are set to reach preset maximum distances, the data packets from each of the one or more unknown positioned electronic labels including identifying data of the particular unknown positioned electronic label it originates from, receiving the data packets signals by the one or more fixed anchor electronic labels, and assuming, based on the preset maximum distances, a maximum distance position, of the one or more unknown positioned electronic labels from which the data packets where received, from each of the one or more fixed anchor electronic labels that received the radio frequency signals.

### CROSS-REFERENCE TO RELATED APPLICATIONS

The present application claims the priority benefit of U.S. Provisional Pat. Application Serial No. 63/319,011 filed on Mar. 11, 2022 and titled “Electronic Label Localization and Mesh Network Desynchronization,” all of which is hereby incorporated by reference in its entirety.

### FIELD OF INVENTION

The present technology pertains to systems and methods for electronic label localization and mesh network desynchronization.

### SUMMARY

In various embodiments the technologies presented herein include a method for presence detection based three-dimensional localization of electronic labels, comprising placing one or more fixed anchor electronic labels in known positions in three-dimensional space; sending data packets via radio frequency signals from one or more unknown positioned electronic labels, wherein the radio frequency signals are set to reach preset maximum distances, the data packets from each of the one or more unknown positioned electronic labels including identifying data of the particular unknown positioned electronic label it originates from; receiving the data packets signals by the one or more fixed anchor electronic labels; and assuming, based on the preset maximum distances, a maximum distance position, of the one or more unknown positioned electronic labels from which the data packets where received, from each of the one or more fixed anchor electronic labels that received the radio frequency signals.

In some embodiments, the method further includes determining an estimated position of each of the one or more unknown positioned electronic labels with assumed maximum distance positions, by taking a mean sum or a weighted sum based on any desired generic metric to be used as a weight in the location calculation of the position of each of the one or more fixed anchor electronic labels that received the data packets.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 depicts an exemplary electronic labels or electronic stickers (defined herein as “electronic label”, “node”, “stamp” or “electronic sticker”) that may also act as a wireless node in a communication network.

FIG. 2 depicts an exemplary embodiment of wireless System on a chip (SoC).

FIG. 3 depicts an exemplary network of electronic labels or electronic stickers as wireless nodes in communication with one another and a gateway.

FIGS. 4A-4D depict the electronic label affixed to different items or assets.

FIG. 5 presents a diagrammatical representation of a mesh-based localization architecture using electronic labels.

FIG. 6 presents some examples of communication ranges and position estimating.

FIG. 7 presents another embodiment of a mesh-based localization architecture.

FIGS. 8A-8E present one embodiment of various stages of a virtual anchor deployment method.

FIG. 9 presents one embodiment of systems and methods for prediction accuracy improvements in a three-dimensional localized mesh architecture.

FIG. 10 presents one exemplary embodiment of a system for using fixed anchors to transmit information on the location of assets identified by electronic labels.

FIGS. 11A-11D present various stages of a method to de-synchronize a wireless mesh network.

FIG. 12 presents a flow chart representation of a method for presence detection based three-dimensional localization of electronic labels.

FIG. 13 is a diagrammatic representation of an example machine in the form of a computer system

### DETAILED DESCRIPTION

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

Indoor three-dimensional localization is a problem and is currently limited to technologies that rely on infrastructure-heavy techniques, or rely on line of sight visibility, these technologies are unreliable, have low accuracy, can be costly and time consuming to set up. What is needed is a lightweight solution that can provide localization of assets in both indoor and outdoor settings that is quickly able to be set up and taken down and does not require large overhead costs. Traditionally, ranging, i.e., actual measurement of distance is used for indoor localization methods in three-dimensional space, through triangulation or other techniques. The technologies herein use a mesh-based localization architecture using electronic labels or nodes to undertake indoor localization. One proposed method is that of presence detection, where bidirectional transmission of radio frequencies is used to estimate the position between different electronic labels or nodes.

Several embodiments of the present disclosure relate to an electronic label, electronic sticker, or stamp that can be attached to any physical item for tracking, provisioning, quantification of item(s), or for measurement of any number of characteristics to assets it is attached to. In exemplary embodiments, the electronic sticker is capable of being attached to any physical item/asset via any attachment means, adhesive, mechanical, or otherwise. The electronic label may in various embodiments be set on a backing liner (liner).

In various exemplary embodiments, the electronic label is a specially designed and manufactured hardware computing chip with external components either attached or printed directly onto the chip. The external components may be any one or more of an attached or printed antenna (to enable wireless communications), a power source (such as a printed battery, or energy harvester), and a sensor. In many embodiments a circuit trace is included on the electronic label, and is connected to the rest of the circuit, preferably directly and immediately connected to the chip. The electronic label may also include capacitors, resistors, and inductors within the electronic circuit on or in the electronic label. The electronic sticker also has wireless firmware, to enable end to end encrypted communications over any wireless network.

Each electronic label may be utilized as a wireless node in a communications network of a plurality of wireless nodes. Furthermore, each electronic label can communicate with other neighboring wireless stickers using standard protocols and communication technologies like Bluetooth, Bluetooth Low Energy (BLE), IEEE 802.15.4, WiFi, etc. The electronic labels can be composed in any configuration to form a full or partial mesh network. Further, each electronic label can connect to one or more centralized gateways, such as a WiFi access point, cell phone, tablet, laptop computer, desktop computer, cellular gateways, Low Power Wide Area Network (LPWAN) gateways, satellite gateways, or any other computing device. The electronic labels can also be utilized in a manner akin to edge devices in a wireless mesh network. In several embodiments, direct communication between the electronic labels and cellular towers, microwave towers, base stations and satellites is possible.

In various embodiments, the electronic label may be used as, or instead of a shipping label and is able to communicate with neighboring labels through a mesh network, created by the multitude of connected individual electronic labels. These electronic labels may communicate directly to each other through various technologies discussed in this document, as well communicate with other devices, servers, local and cloud networks, and databases through internet communications via a connection to one or more gateway devices or access points.

In several embodiments, each electronic label has its own unique digital identifier (unique ID), and in some embodiments, asset information may be added to the electronic label by printing information directly on the label, this information may include shipping data, other identifiers, and customer or merchant generated information. In some embodiments a printer or other printing device may be used to add the information to the label by printing the information, barcode, serial number, or other identifier on the label. In various embodiments once the data is printed onto a label, it is then read by a visual sensor and the unique digital identifier of the electronic label as well as the asset information are linked or associated together. The linking of the added information may additionally be done in the cloud, and in some embodiments, the linking or associating of the unique digital identifier of the electronic label with the asset information is undertaken without any physical printing on the label.

The computing chip on the label may be in a sleep mode, low-power mode, or may be partially or completely powered off or inactive depending on the preprogramming of the chip (these collectively referred to as “low power mode”). In some embodiments the chip may contain one low power core that is active, while the other cores are turned off or in a low power or sleep state.

In several embodiments, the chip may be activated based on geolocation information, this activation method may be carried out in a variety of ways. In various embodiments, the location of the label (which may or may not have been placed on an asset), is triangulated by one or more locators or gateways by detecting the transmissions or signals the label is sending; prior to activation these are usually infrequently sent radio frequency signals which are detected by these gateways which determine whether the label is to be activated, if the label is at a designated location or area, the gateways send a command to the label, via the sensor, the chip or otherwise, to activate the chip. In some embodiments, the location of the label can be computed by the label itself; this is done by the label receiving reference signals from one or more locators or gateways; the label then determines if it is at a designated activation location and if so activates. In preferred embodiments, triangulation of the label’s location may be carried out by one or more gateways, devices, fixed anchors, sensors, nodes, or towers which receive signals that may be periodic in nature, or radio frequency transmissions from the label, and/or from a sensor such as a GPS or geolocation sensor or other sensor, and in others from the chip itself. The sensor(s) discussed may be on or part of the chip, or separate and external and embedded on the label and connected to the chip, and in some embodiments a combination of both types of sensors may be used. In some embodiments the chip receives readings or instructions either from the sensor, a gateway, or a computing device to activate. In several embodiments, the electronic label is programmed to automatically be activated when it is near a specific device including a designated computing or mobile device or be activated by a variety of methods such as scanning a QR code, an infrared serial number and the like with a device that utilizes one or more visual sensors including cameras, infrared sensors, and the like.

Once the chip on the label is activated, then it may begin carrying out several things, in some embodiments it may begin to periodically send confirmation of activation, location data as well as other information to nearby devices, which may include gateway devices, other computing devices and the like to be transmitted to a cloud network or server.

Each electronic label can transmit either all the raw data to a gateway, or transmit only select pieces of information, such as location and/or time data. The specific data transmitted to the gateway and the time interval at which the data is transmitted to the gateway may be customizable. The frequency of transmission and the cost of transmission are important factors for bandwidth and power usage limitations. Alternatively, or additionally, data can be transmitted from an electronic sticker directly to a user computing device (such as a smartphone, table, smartwatch, laptop, etc.) or from a gateway to a user computing device. The gateway device may transmit this information to a cloud using backhaul communication either through wired or wireless infrastructure.

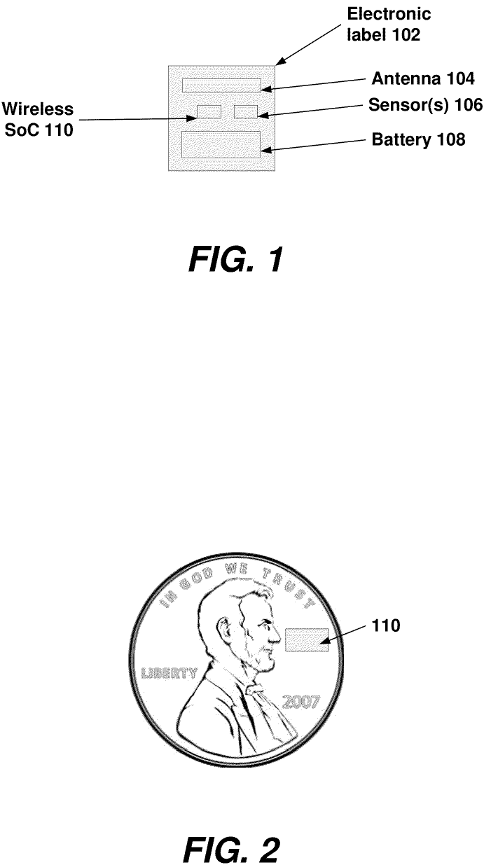

FIG. 1 depicts an exemplary electronic sticker 102, which may also act as a wireless node in a communication network as discussed herein. The sticker 102 may have an antenna 104. The antenna may be printed directly onto the hardware chip, or separately attached. Sticker 102 may also have one or more sensor(s) 106. In exemplary embodiments, sensor(s) 106 may be any of a resistor-based, capacitor-based, inductor-based sensor, a location sensor, time sensor, temperature sensor, clock, humidity sensor, or any other type of sensor relating to a characteristic for measurement. Sticker 102 also comprises battery 108, which may be a printed battery printed directly onto the hardware chip. Wireless SoC 110 (wireless chip) may also be a part of sticker 102, enabling wireless communication capability for sticker 102, such that sticker 102 acts as a wireless node in a computing network. While not expressly depicted, other components may also be present on sticker 102. Further, the components of sticker 102 may be of differing size or in a differing location on sticker 102 than shown in the exemplary figure.

Sticker 102 may be of any size practical for attachment to an object. In an exemplary embodiment, the electronic sticker may be 2 cm x 2 cm.

Wireless SoC 110 may be of a size practical for inclusion on sticker 102. In exemplary embodiments, the chip is 1 square millimeters in size. In other embodiments, the wireless SoC can of other sizes, such as 6 square millimeters (3 mm x 2 mm), 4 square millimeters (2 mm x 2 mm), or any other size.

FIG. 2 depicts an exemplary embodiment of wireless SoC, to show a relative size of wireless SoC in comparison to a penny in US currency. Any SoC with any size supporting wireless communication capability can use the localization methods discussed herein.

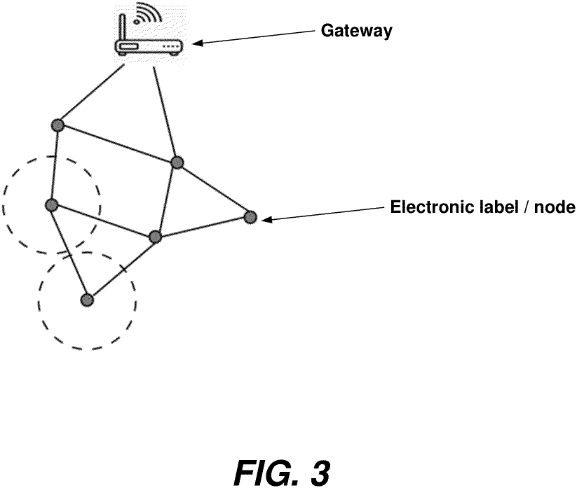

FIG. 3 depicts an exemplary network of electronic stickers as wireless nodes, in communication with one another and a gateway. While only a few nodes are depicted for simplicity, there can be millions of nodes in a network. Further, while not expressly depicted in the figure, there can be any number of other components in the network as well, such as routers, switches, actuators, drones, handheld computing devices, robots, industrial robots and/or other devices.

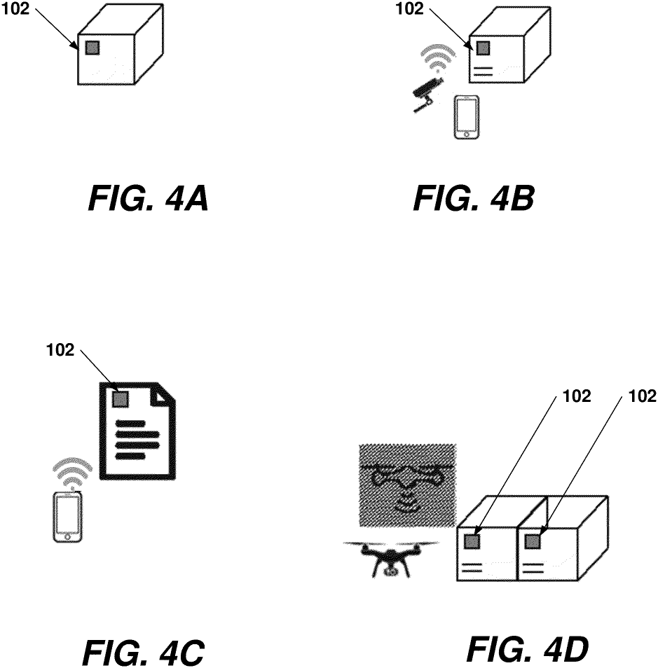

FIGS. 4A-4D depict the electronic label 102 affixed to different items or assets. Each electronic label 102 possesses a unique digital identifier that can provide digital serialization services in addition to other benefits (e.g. traceability, authentication, and anti-counterfeiting services, etc.). That is, by reading the digital label by any enabled wireless computing device, a history of location of the item can be traced, tracked, and authenticated.

The unique digital identifier of each electronic label is linked to the shipping information, data, other asset or package information and data or other types of identifiers provided or generated by the merchant or customer. As shown in FIG. 4B, this provisioning process can be done by first reading the previous serialization information through a vision-based system, e.g., through a commercial camera, infrared sensor or scanner, portable camera (on a mobile phone, tablet, etc.), or a hardware device programmed to read holographic images. In some embodiments the printer which prints the label may also include a sensor or camera that can read the printed shipping information (and other data) as well as the unique digital identifier of each label and provide this information to the cloud or a gateway or computing device linking the digital label 102 with the printed information. The hardware used may also transfer this information over a wireless link to the digital label 102 and link the unique digital identifier of the label 102 with the shipping or other information. This process is automated without requiring any human intervention. Thus, thousands of items can be provisioned automatically in this manner, at a much greater speed than current systems that require human involvement. Further, with the automation, there is a reduced chance of human error.

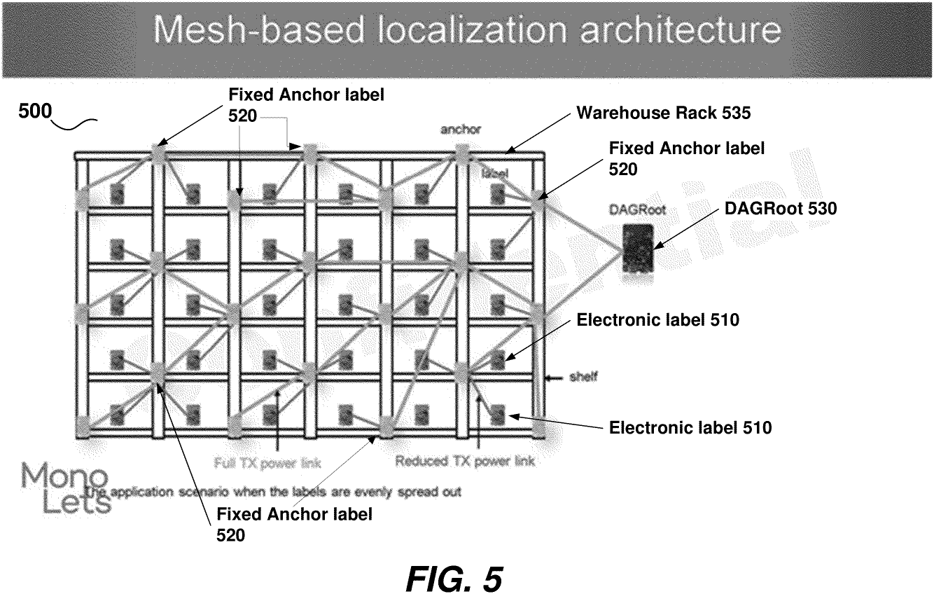

FIG. 5 presents a diagrammatical representation of a mesh-based localization architecture 500 using electronic labels 510 (also referred to herein as “nodes”, “wireless nodes”, or “electronic nodes”) and fixed anchor electronic labels 520 (also referred to herein as “anchors”, “fixed anchors, “fixed anchor labels” or “anchor labels”) that have a fixed or known position or location, these anchors collect data and transmit or forward data to any gateway-like/central device acting as the root of the mesh, one example of which is DAGRoot 530, where the data is processed and used to calculate the positions of the anchors and/or electronic nodes. Data collection could include various methods including presence detection, or range measurements. An exemplary use case is placing the electronic labels 510 on pellets, assets, or products placed in slots in a warehouse rack 535, shelf, or other divided storage. Fixed anchors 520 may be placed around the warehouse rack 535, on the ceiling or at known fixed positions with known coordinates. The aim would be to use the known positions of the fixed anchors 520 to determine the location and position of each of the electronic labels 510 in the warehouse. This would allow positioning of whatever asset or products electronic labels 510 are placed on. The electronic labels 510 all transmit and send out radio frequency signals, each of the electronic labels 510 has preset ranges its signal may reach and data packets may be sent. The preset ranges could be configured to use several settings with different maximum ranges, i.e., TxPower levels. This provides more information to the localization algorithm. Therefore, when a data packet or signal is received by a fixed anchor label 520, then it is known how far or within what range the transmitting device or particular electronic label 510 is positioned from the fixed anchor 520. The fixed anchor 520 knows how far the maximum range is according to the TxPower settings set at the electronic label 510 side. This information can be added into the data packet being transmitted. This estimation of a distance range a label is within from an anchor is referred to herein as presence detection.

In various embodiments, the data packet may contain the information indicating the range limit of the particular electronic label 510, in other embodiments the electronic label may have a certain range based on its generation or model number. In preferred embodiments the transmission range of an electronic label 510 is set and determined by a preset transmitter output power. Therefore, the presence detection technique can ascertain the range within an electronic label 510 is from a fixed anchor, if a fixed anchor 520 receives a data packet or other signal from the electronic label 510.

In various embodiments, presence detection is followed by data collection and processing across one or more of the electronic labels 510 and fixed anchors 520. In various embodiments data is collected from all these electronic labels 510 and fixed anchors 520. Then an algorithm is deployed to make estimates of where each electronic label 510 is located relative to each fixed anchor 520 to obtain an estimated position for each electronic label 510. This information is then used to determine in which slot, which shelf or what area of a warehouse the electronic label is set. Several parameters may be used to determine or refine the estimated position of which slot in the warehouse is occupied by which label, these include a strength of transmission parameter as well as parameters base on other data that is collected from the electronic labels 510.

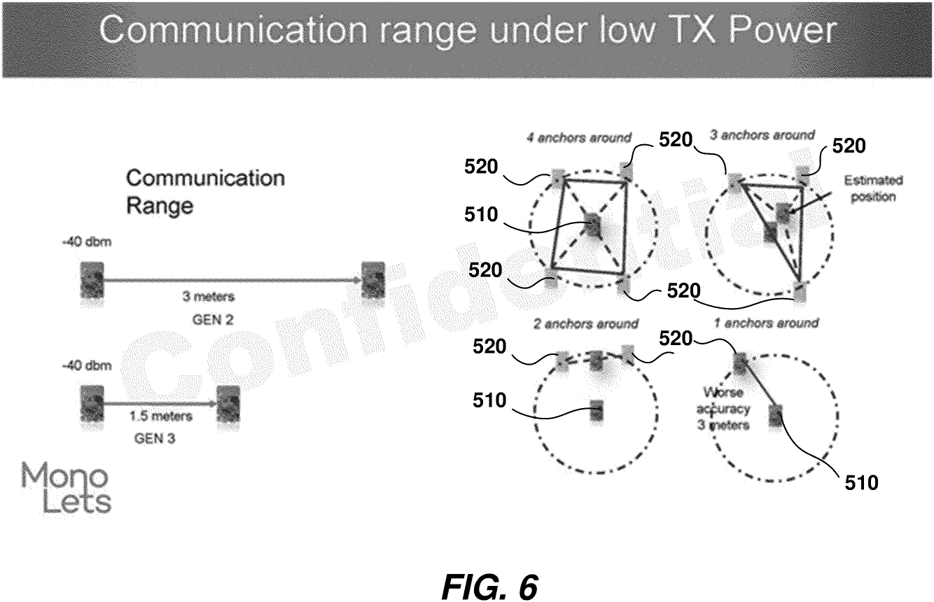

FIG. 6 presents some examples of communication ranges and position estimating. A communication range for an electronic label may be determined by the model, or generation or the preset settings or power usage.

After presence detection is undertaken to determine an estimated location of an electronic label 510 and its range within fixed anchors 520 that detect it the position of an electronic label 510 is determined by taking a weighted sum of each of the fixed anchors 520 that detect it. Therefore, the more fixed anchors 520 that detect an electronic label 510 or can receive signals from it, the more accurate the estimate position will be of that electronic label 510. The positioning estimate will be based on the weighted sum of the positions of the fixed anchors 520, since the positions in three-dimensional space of each fixed anchor is known and fixed. This in turn provides x,y or or x,y,z coordinates of the electronic label 510.

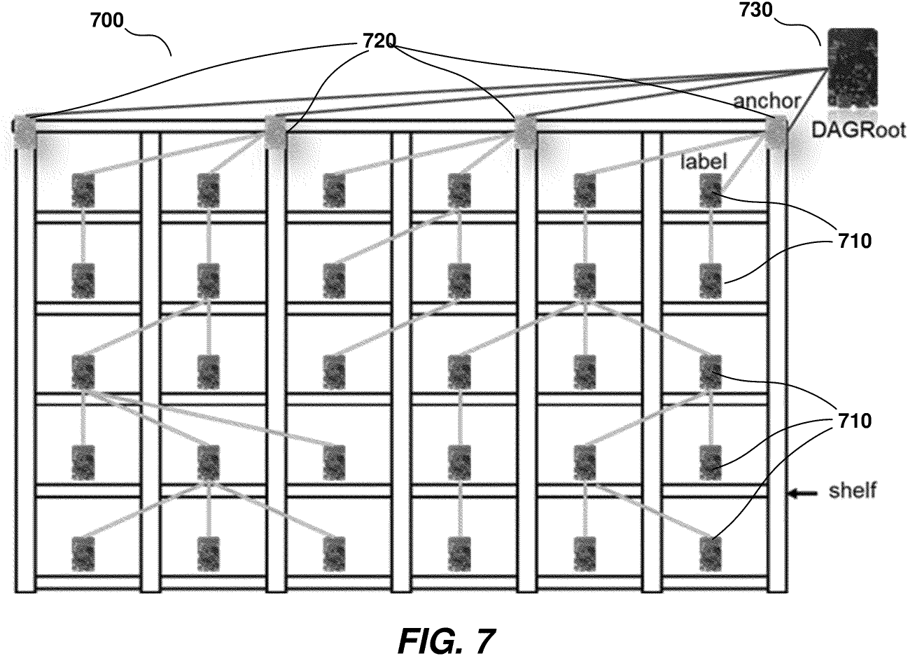

FIG. 7 presents a variation on the mesh-based localization architecture in FIG. 5. In the variation model, a mesh network is created between all the labels, and much fewer fixed anchors 720 are placed around the warehouse, in this exemplary embodiment four fixed anchors 720 are placed at the ceiling or high up in the warehouse and receiving a controlling signal from DAGRoot 730. The fixed anchors 720 use either presence detection and/or the other techniques described in FIG. 5 and/or ranging distance measurement to determine the location of the electronic labels 710 that are placed on the top row and localize the electronic labels 710 at the top row. Once the electronic labels 710 are localized at the top row, then their localized positions are used to localize the electronic labels 710 on the row below them. Each electronic label 710 or node does this to the electronic label or node below it, this is an iterative process until all the electronic labels 710 on the mesh network in the warehouse are localized.

In several embodiments, each of the electronic labels 710 are able to undertake radio roundtrip measurements (RTT), i.e., ranging measurements of actual distance over the wireless mesh network. Each of the electronic labels 710 can carry out RTT with any other electronic label 710 its signal may reach or transmit to. In preferred embodiments each node can undertake RTT along with its nearest electronic label 710 neighbors. RTT may be undertaken in any of the architectures and embodiments presented herein including those of FIGS. 5, 7, and 8A-8E.

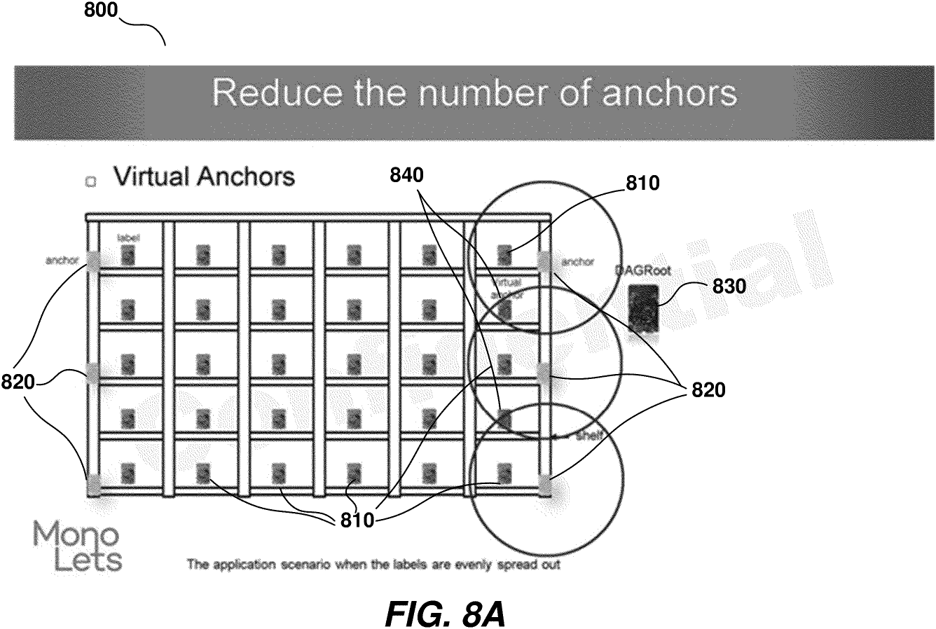

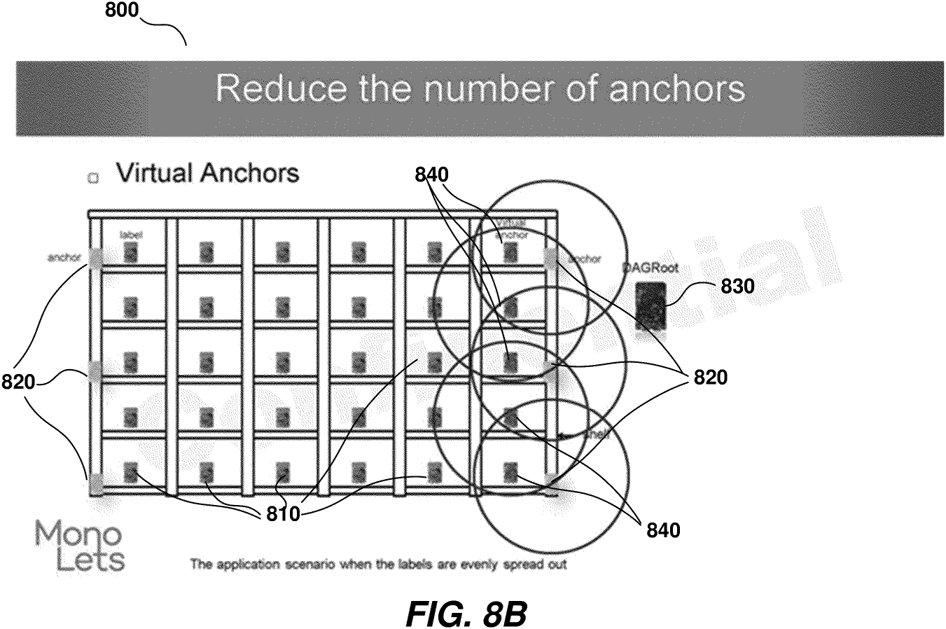

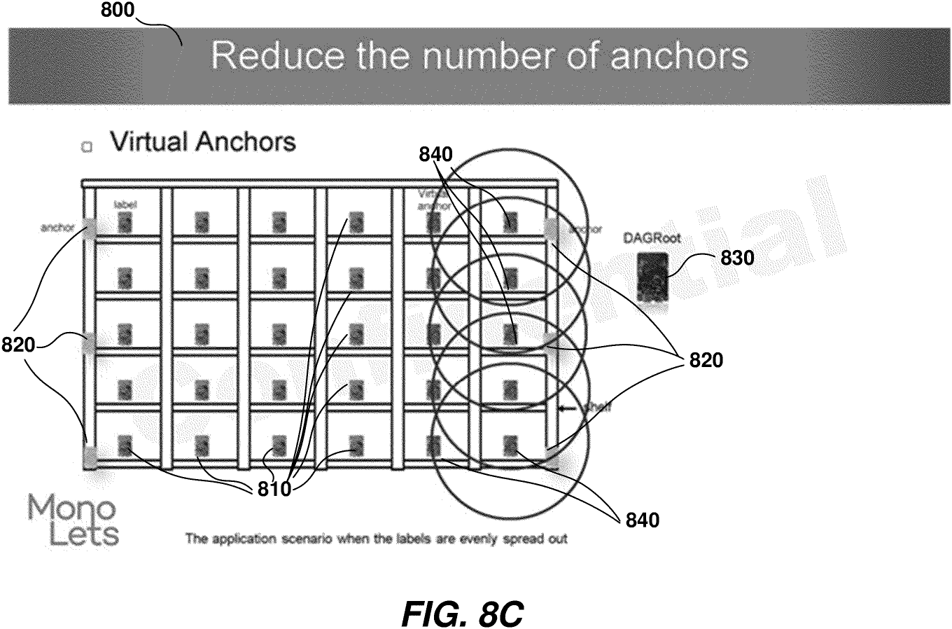

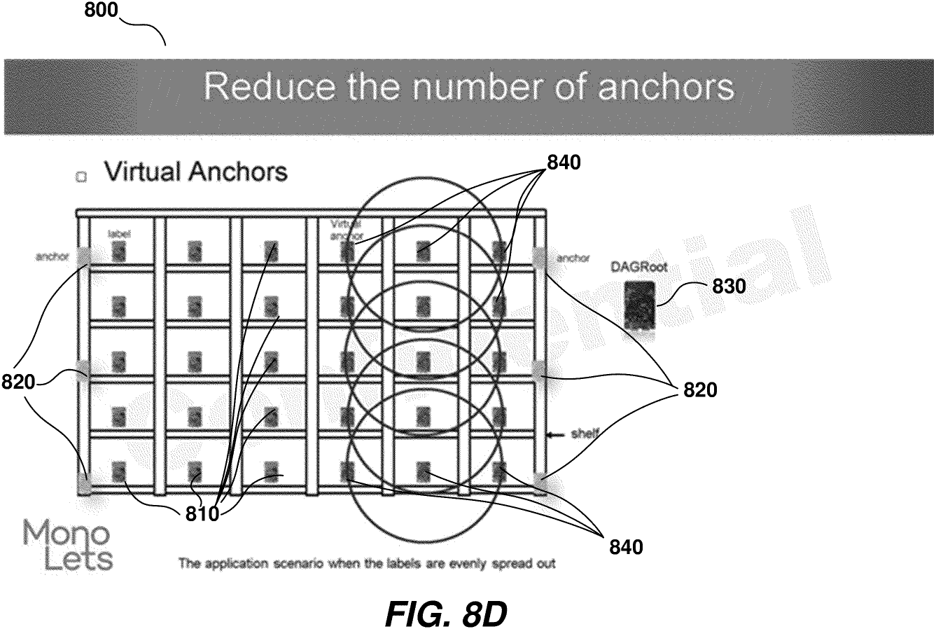

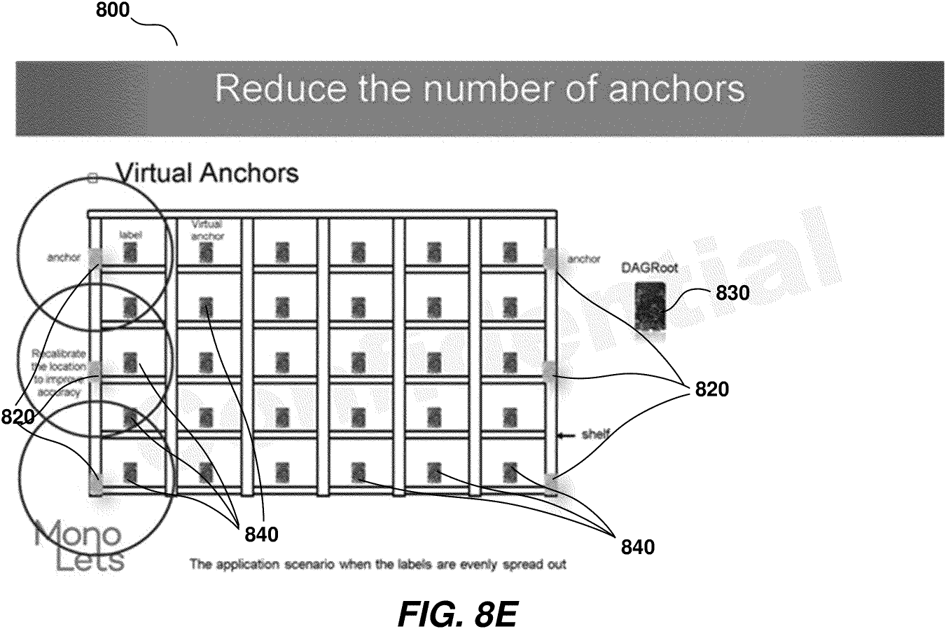

FIGS. 8A-8E present one embodiment of various stages of a virtual anchor deployment method 800. A reduced number of fixed anchors 820 controlled by DAGRoot 830 are placed in one side of a warehouse or warehouse rack. Electronic labels 810 are deployed throughout the rack or warehouse on warehouse shelves or other positions. Fixed anchors 820 positions are known, they are able to localize the electronic labels 810 that are near them, once they are localized, they turn into virtual anchors 840 with known fixed positions. These virtual anchors 840 are then in turn used to localize the next row or column of electronic labels 810 turning them into virtual anchors 840. This process is repeated until all electronic labels 810 are captured and localized and turned into virtual anchors 840. The fixed anchors 820 on the other side of the warehouse then may be used to calibrate the positions further of the virtual anchors 840 that are nearest to them, which in turn may go back to the other direction and calibrate the virtual anchors near them and so forth. This back-and-forth calibration will then lead to much improved presence and positioning estimation. Both ranging and presence detection methods may be used.

Furthermore, fixed anchors may be utilized as calibration points in any of the embodiments presented in these FIGS. 5, 7, and 8A-8E. Fixed anchors 520, 720, 820 may all be used as a reset system or calibration points. Calibration can occur between fixed anchor (520, 720, 820) to fixed anchor (520, 720, 820) since we know the fixed positions of these fixed anchors (520, 720, 820) we use these known fixed positions to measure distances via ranging methods to calibrate the overall system to reduce error.

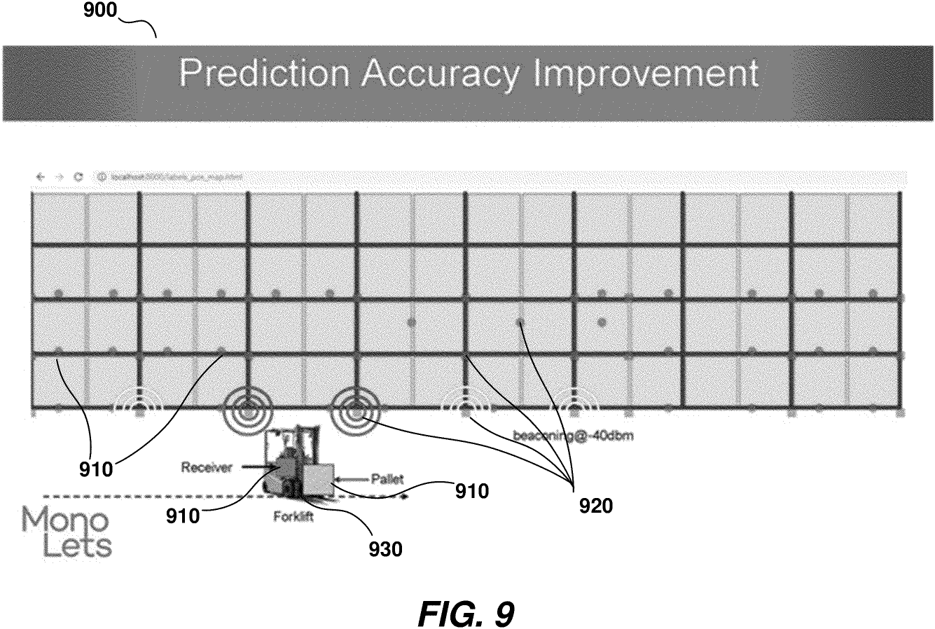

FIG. 9 presents one embodiment of systems and methods for prediction accuracy improvements 900 in a three-dimensional localized mesh architecture. This method may be used to track mobile products and assets such as forklifts or pellets being transported in real time in indoor settings such as a warehouse. In this embodiment a number of fixed anchors 920 are placed in known fixed positions around the warehouse. The fixed anchors 920 beacon or transmit radio frequencies. These fixed anchors 920 used as transmitting beacons at predefined intervals. These beacons are received by wireless nodes or electronic labels 910 or a wireless device attached to any mobile or other asset 930, which send this information wirelessly to the cloud. If beacons or radio frequency signals are received from one or more anchors, then the position of these anchors may be used to compute the position of the mobile asset 930 in real time via ranging methods, presence detection or any of the other methods discussed herein. Computations may take place on electronic devices that receive the data or on a cloud computing network. The full wireless mesh network architecture may be used to compute the position of mobile assets, including any or all electronic labels 910 and fixed anchors 920.

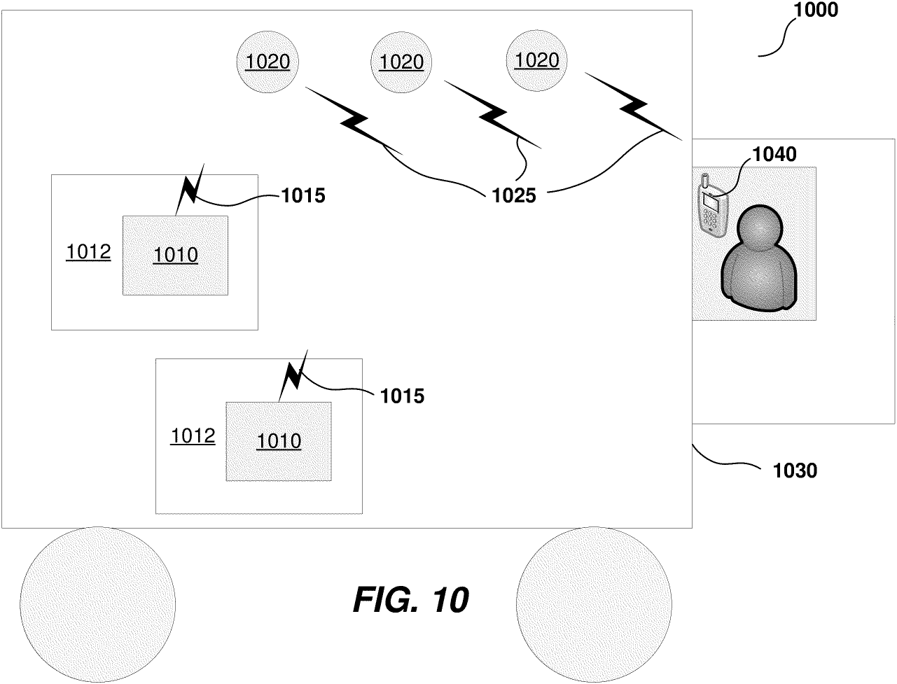

FIG. 10 presents one exemplary embodiment of a system 1000 for using fixed anchors 1020 to transmit information on the location of assets identified by electronic labels 1010. In this embodiment pellets or products 1012 are placed in a truck or other moving vehicle 1030. An electronic label 1010 is affixed on each pellet or product 1012. The electronic labels 1010 beaconing or sending an active transmission signal 1015. Fixed anchor labels 1020 are also placed in a fixed position inside the truck and receive the signals 1015 from the electronic labels 1010. The fixed anchors 1020 then transmit the data received from the electronic labels 1010 via a long-range Bluetooth (BLE) connection or transmission, or other signal transmission long range modulations to a computing device, cellular device, smart phone, or other capable device 1040 with the driver in the driver cabin, which may in turn undertake processing of the data or upload the data to a cloud network. The fixed anchors 1020 use a long-range link, different modulation schemes or different power levels, for example by containing larger batteries or having access to larger power sources that allow them to amplify and/or transmit the signal and/or data across longer distances and through different compartments or cabins in a truck or other transport vehicle 1030.

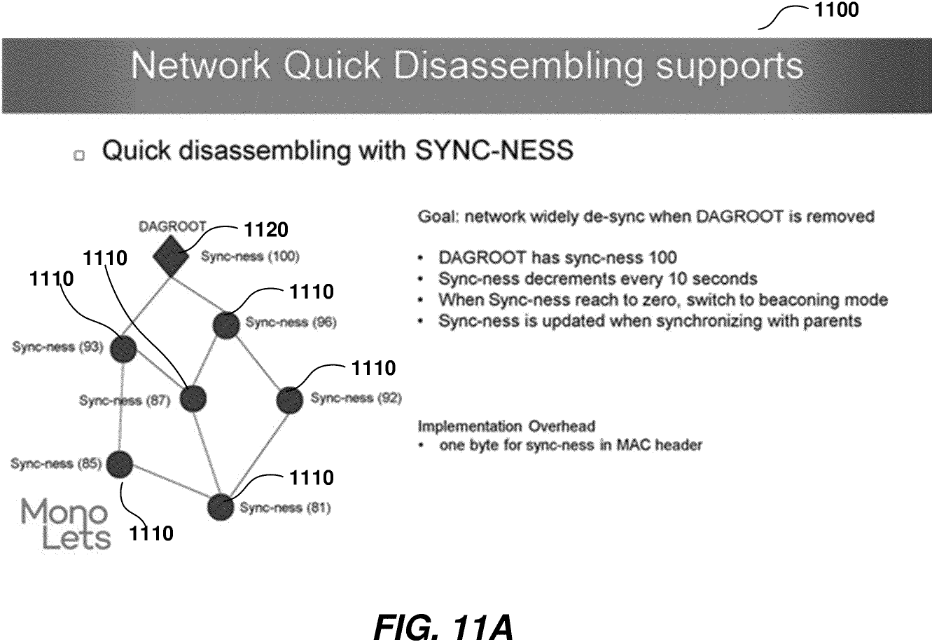

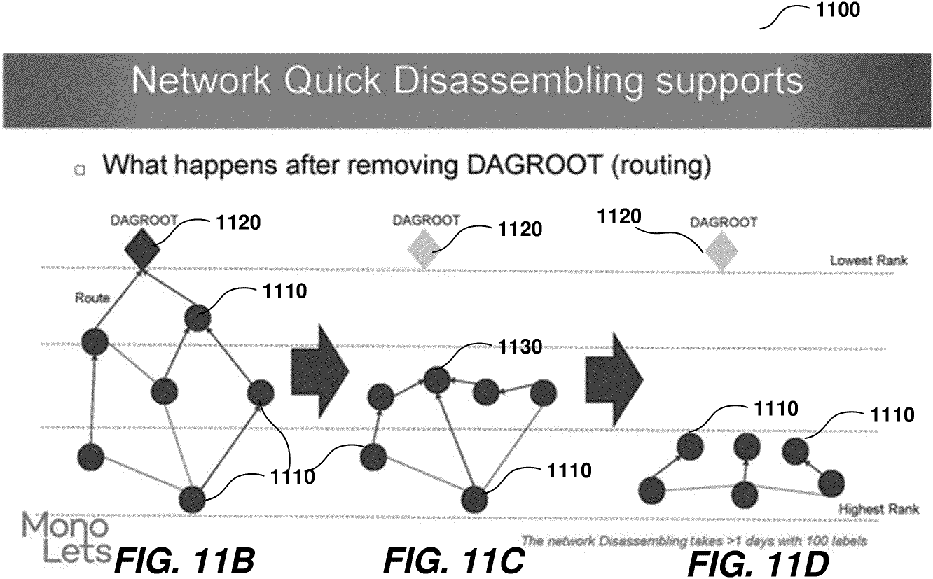

FIGS. 11A-11D present various stages of a method 1100 to de-synchronize a wireless mesh network. In FIG. 11A, the presented initial state is an assembled and synchronized wireless mesh network, where all devices/electronic labels 1110 are synchronized to each other and in turn to a controller device or node DAGROOT 1120. Issues may arise if controller DAGROOT 1120 is taken offline, disconnected, or powered off, because all the other electronic labels 1110 or nodes synchronize to it, they are unable to de-synchronize in an ordered and timely manner without a particular protocol or methodology.

Initially, when the wireless mesh network is formed, all the electronic labels 1110 or devices are time synchronized and are following the same communication schedule. This communication schedule is maintained by the mesh wireless network controller DAGROOT 1120. If DAGROOT 1120 is offline, for whatever reason including wireless failure or link failure. We want all the nodes to de-synchronize quickly and lose all synchronization information. Otherwise in many instances nodes will keep trying to synchronize to each other, creating fluctuations increasing the time for electronic labels 1110 to desynchronize.

In the embodiment presented herein the de-synchronization method places a “sync-ness” value on each electronic label 1110 as well as DAGROOT 1120. DAGROOT 1120 has the highest sync-ness assigned value relative to the other nodes, in some instances it may have the maximum possible value. Each node or electronic label 1110 connected directly or indirectly through mesh to DAGROOT 1120 then has a sync-ness value that is lower than that of DAGROOT 1120. Each electronic label 1110 in turn then has a sync-ness value assigned to it that is lower than that of an electronic label 1110 it is connected to that is connected closer to DAGROOT 1120. As the number of connections increase, each electronic label 1110 further removed from DAGROOT 1120 has an increasingly lower sync-ness value.

As long as there are radio frequency packets or data packets (herein referred to as a “synchronization packet”) being received by the electronic labels 1110 and received periodically, then the sync-ness value is maintained. But as soon as DAGROOT 1120 is disconnected, powered off or taken offline, then the nodes stop receiving these data packets. A timeout parameter is preset, such that for whenever a data packet is not received within a certain period then sync-ness value keeps decreasing by a certain value to the point that it reaches 0, every node/electronic label 1110 also does that, since they also do not receive packets from the other nodes/electronic label 1110.

Once DAGROOT 1120 is disconnected, powered off, or removed from the network it can be determined and/or controlled how long it would take for the whole network to disassemble or de-synchronize based on the timeout parameters and the sync-ness values, and the rate of decreasing the sync-ness values of each node/electronic label 1110.

In FIG. 11B it can be seen that DAGROOT 1120 is connected to the mesh network comprised also of electronic labels 1110. Once DAGROOT 1120 is disconnected in FIG. 11C then the nearest electronic labels 1130 no longer receives synchronization packets from DAGROOT 1120, its sync-ness value decreases until it disconnects in FIG. 11D. In various embodiments once electronic label 1130 stops receiving synchronization packets from DAGROOT 1120 it then in turn also stops synchronization packets to the rest of the network and electronic labels 1110 connected to it, so that the whole network begins desynchronization relatively at similar times. However, in other embodiments, the electronic label 1130 must first be disconnected and de-synchronized from the network before it stops synchronization packets, and therefore the electronic labels 1110 connected to nearest electronic label 1130 only begin the de-syncing process where their sync-ness value goes down once electronic label 1130 desynchronizes completely.

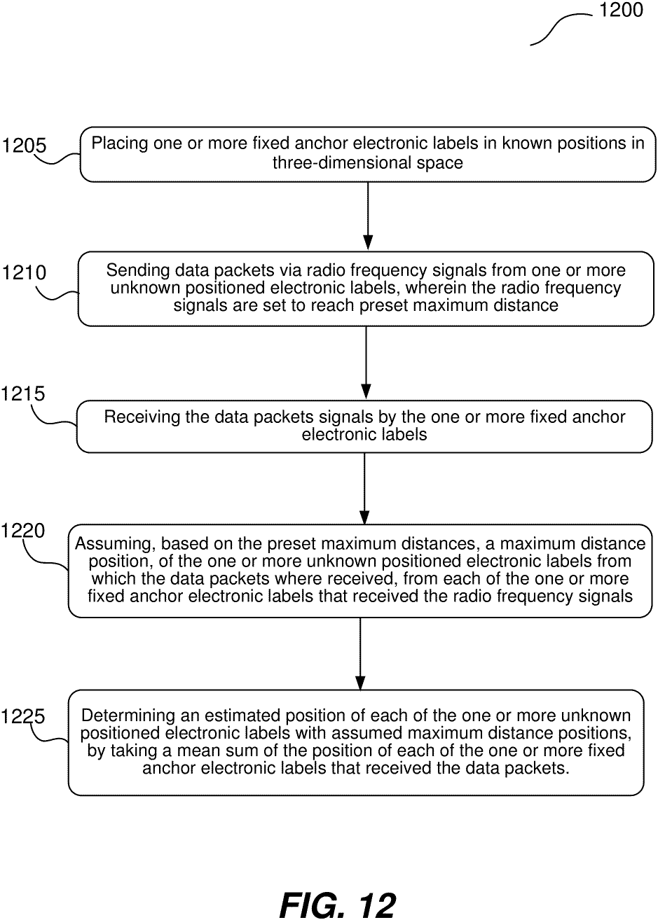

FIG. 12 is a flow chart representation of a method 1200 for presence detection based three-dimensional localization of electronic labels. At least one fixed anchor electronic label is placed 1205 in known positions in three-dimensional space. One or more electronic labels are also placed in three-dimensional space, for example, on different pellets throughout a warehouse or other storage indoor space. The positions of the one or more electronic labels may be unknown or undetermined unliked the anchor labels. In various embodiments, the electronic labels of both the fixed and the non-fixed position type are identical in hardware design. Data packets are transmitted, beaconed, or sent 1210 from the one or more electronic labels and are received by anchor labels. The radio frequency signals of each non-fixed electronic label may be preset or programmed to only reach a certain distance, and therefore when the data packets are received 1215 by fixed anchor labels, therefore an assumption can be made 1220 that the distance of an electronic label whose data packet reached a nearby anchor labels is within a certain range (the preset maximum distance) from the fixed anchor electronic label that received the data packet. This is repeated at all fixed anchor labels with all data packets received. Whenever a data packet is received, then a max distance is assumed between the transmitting electronic label and the fixed anchor electronic label. The preset distance may be determined by the data packet itself and its content, the type of transmitter, the type of electronic label and any other suitable parameter or information that may be used to indicate or identify the preset maximum range of the transmission. By using more than one fixed anchor electronic label and receiving the same data packet from the same electronic label at different fixed anchor nodes or labels, then a weighted sum based on the fixed positions of the anchor labels may be used to estimate 1225 a position of the transmitting electronic label in three-dimensional space.

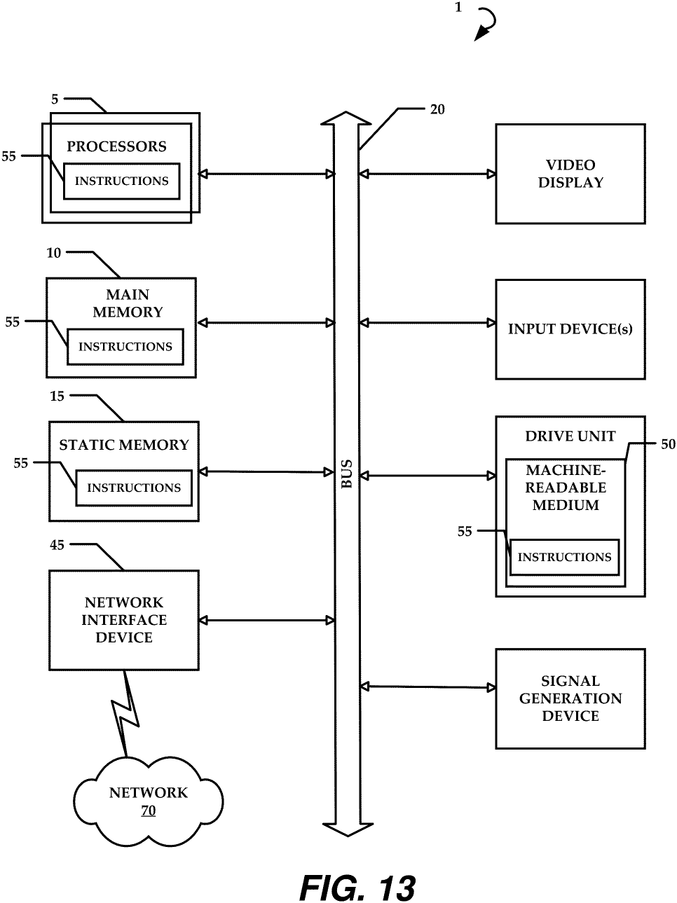

FIG. 13 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The components provided in the computer system 1 are those typically found in computer systems that may be suitable for use with embodiments of the present disclosure and are intended to represent a broad category of such computer components that are known in the art. Thus, the computer system 1 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network 70 via the network interface device 45 utilizing any one of several well-known transfer protocols (e.g., Hyper Text Transfer Protocol (HTTP)). While the machine-readable medium 50 is shown in an example embodiment to be a single medium, the term “computer-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the embodiments of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 215 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described to best explain the principles of the present technology and its practical application, and to enable others of ordinary skill in the art to understand the invention for various embodiments with various modifications as are suited to the particular use contemplated.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A method for presence detection based three-dimensional localization of electronic labels, comprising:
placing one or more fixed anchor electronic labels in known positions in three-dimensional space;
sending data packets via radio frequency signals from one or more unknown positioned electronic labels, wherein the radio frequency signals are set to reach preset maximum distances, the data packets from each of the one or more unknown positioned electronic labels including identifying data of the particular unknown positioned electronic label it originates from;
receiving the data packets signals by the one or more fixed anchor electronic labels; and
assuming, based on the preset maximum distances, a maximum distance position, of the one or more unknown positioned electronic labels from which the data packets where received, from each of the one or more fixed anchor electronic labels that received the radio frequency signals.

2. The method of claim 1, further comprising:
determining an estimated position of each of the one or more unknown positioned electronic labels with assumed maximum distance positions, by taking at least one of a mean sum or a weighted sum of the position of each of the one or more fixed anchor electronic labels that received the data packets.

3. The method of claim 2, further comprising:
synchronizing all of the one or more fixed anchor labels to all of the one or more unknown positioned electronic labels.

4. The method of claim 3, further comprising:
time synchronizing all of the one or more fixed anchor labels and all of the one or more unknown positioned electronic labels to a mesh wireless network controller.

5. The method of claim 4, further comprising:
maintaining a communication schedule by the mesh wireless network controller.

6. The method of claim 5, further comprising:
placing a sync-ness value on each electronic label.

7. The method of claim 6, further comprising:
placing a sync-ness value on the mesh wireless network controller.

8. The method of claim 7, further comprising:
assigning a highest sync-ness value to the mesh wireless network controller relative to other nodes.

9. The method of claim 8, further comprising:
assigning a maximum possible value the mesh wireless network controller relative to other nodes.

10. The method of claim 9, further comprising:
each electronic label having a sync-ness value lower than the mesh wireless network controller.

11. The method of claim 10, further comprising:
each electronic label having a sync-ness value lower than that of an electronic label connected closer to the mesh wireless network controller.

12. The method of claim 11, further comprising:
maintaining sync-ness values as synchronization packets are periodically received by the electronic labels.

13. The method of claim 12, further comprising:
stopping receipt of the synchronization packets when the mesh wireless network controller is disconnected, powered off or taken offline.

14. The method of claim 13, further comprising:
presetting a timeout parameter.

15. The method of claim 14, further comprising:
decreasing the timeout parameter for whenever a data packet is not received within a previous timeout parameter.

16. The method of claim 15, further comprising:
stopping transmission of all data packets when a single timeout parameter has a value of zero.

17. The method of claim 16, further comprising:
determining a period of time for how long it would take for an entire network to de-synchronize.

18. A method for generating a virtual anchor, the method comprising:
placing a fixed anchor controlled by a mesh wireless network controller on a first side of a warehouse or a warehouse rack;
localizing an electronic label by the fixed anchor;
turning the electronic label into a virtual anchor with a known fixed position.

19. The method of claim 18, further comprising:
localizing additional electronic labels with fixed anchors and virtual anchors or virtual anchors only until all electronic labels are turned into virtual anchors.

20. The method of claim 19, further comprising:
estimating position error in an iterative algorithm by using a virtual anchor to find a position of a fixed anchor.

21. A method for tracking a mobile asset, the method comprising:
placing a fixed anchor in a known position;
beaconing a first radio frequency at a predefined interval;
receiving the beaconing of the first radio frequency by a wireless node attached to a mobile asset; and
sending the beaconing of the first radio frequency by the mobile asset to a cloud.

22. The method of claim 21, further comprising:
using a radio frequency signal received from one or more anchors for computing a position of the mobile asset.
